(19) United States
(12) Patent Application Publication
(10) Pub. No.: US 2025/0144663 A1
(43) Pub. Date: May 8, 2025

(54) CARTRIDGE AND PNEUMATIC DISPENSER

(71) Applicant: CREATIVE21 CO., LTD, Nagoya-shi, Aichi (JP)

(72) Inventors: Masaki KAMATANI, Tokyo (JP); Hirohisa NAKAMURA, Nagoya-shi (JP)

(73) Assignee: CREATIVE21 CO., LTD, Nagoya-shi, Aichi (JP)

(21) Appl. No.: 18/836,299

(22) PCT Filed: Feb. 8, 2023
(86) PCT No.: PCT/JP2023/004191

§ 371 Date: Aug. 6, 2024

(30) Foreign Application Priority Data
Feb. 8, 2022 (JP) 2022-017744

(51) Int. Cl. B05C 17/015; B65D 83/64

(52) U.S. Cl. CPC B05C 17/015; B65D 83/64

(57) ABSTRACT

Provided is a cartridge that is capable of being loaded in a pneumatic dispenser. The cartridge includes a cylinder including a tubular portion capable of accommodating a viscous material therein and a discharge port for discharging a viscous material inside the tubular portion the tubular portion having a tubular shape extending in an axial direction, and a plunger that is provided in a manner of being able to move forward and backward in the axial direction inside the cylinder and has any one of a spherical shape, a pseudo-spherical shape, an oval spherical shape, and a polyhedral shape.

### TECHNICAL FIELD

The present disclosure relates to a cartridge and a pneumatic dispenser.

Priority is claimed on Japanese Patent Application No. 2022-017744, filed Feb. 8, 2022, the content of which is incorporated herein by reference.

### BACKGROUND ART

When a viscous material having a high viscosity, such as a sealing material, is used for coating or filling, a pneumatic dispenser is sometimes used. For example, regarding such a pneumatic dispenser, Patent Document 1 discloses a constitution including a cylinder that has a tubular shape and a plunger capable of moving forward and backward inside the cylinder. In this constitution, the plunger includes a tubular main body portion that extends in an axial direction, a ridge that is formed on an outer circumferential surface of the main body portion and extends in the axial direction, and a seal portion that seals a space between the outer circumferential surface of the main body portion and an inner circumferential surface of the cylinder in a state in which the plunger is fitted into the cylinder. In such a constitution, the outer circumferential surface of the plunger in a fitted state has a clearance in a radial direction with respect to the inner circumferential surface of the cylinder. Consequently, a tubular clearance is formed between the outer circumferential surface and the inner circumferential surface.

### CITATION LIST

### Patent Document

### [Patent Document 1]

Japanese Patent No. 5651803

### SUMMARY OF THE INVENTION

### Technical Problem

However, in the constitution disclosed in Patent Document 1, the plunger has the tubular main body portion and opens rearward. For this reason, due to a pressure acting on the main body portion from a viscous material entering the tubular clearance, stress concentration may occur in the main body portion or a boundary part between the main body portion and the ridge, and the like, which may cause occurrence of damage such as cracking in the plunger. In addition, if the plunger having the tubular main body portion is skewed with respect to the axial direction of the cylinder when it moves forward and backward inside the cylinder, the frictional resistance occurring between the plunger and the cylinder increases so that movement of the plunger may be hindered.

The present disclosure has been made in order to resolve the foregoing problems, and an object thereof is to provide a cartridge and a pneumatic dispenser, in which stress is unlikely to be concentrated with respect to a plunger.

### Solution to Problem

In order to resolve the foregoing problems, a cartridge according to the present disclosure is capable of being loaded in a pneumatic dispenser. The cartridge includes a cylinder including a tubular portion capable of accommodating a viscous material therein and a discharge port for discharging a viscous material inside the tubular portion, the tubular portion having a tubular shape extending in an axial direction, and a plunger that is provided in a manner of being able to move forward and backward in the axial direction inside the cylinder and has any one of a spherical shape, a pseudo-spherical shape, an oval spherical shape, and a polyhedral shape.

A pneumatic dispenser according to the present disclosure includes the cartridge described above, a cartridge accommodation portion that is capable of accommodating the cartridge, and an air pressure supply portion that supplies air pressure to the cartridge accommodated in the cartridge accommodation portion and pushes the plunger in the axial direction inside the cylinder.

### Advantageous Effects of Invention

According to a cartridge and a pneumatic dispenser of the present disclosure, stress is unlikely to be concentrated with respect to a plunger.

### BRIEF DESCRIPTION OF THE DRAWINGS

FIG. 1 is a side sectional view of a pneumatic dispenser including a cartridge according to an embodiment of the present disclosure.

FIG. 2 is a side sectional view showing a state in which a plunger has moved to a first side in an axial direction in the cartridge according to the embodiment of the present disclosure.

FIG. 3 is a side sectional view showing a constitution of the cartridge according to a modification example of the embodiment of the present disclosure.

### DESCRIPTION OF EMBODIMENTS

### (Constitution of Pneumatic Dispenser)

Hereinafter, an embodiment of the present disclosure will be described using the drawings.

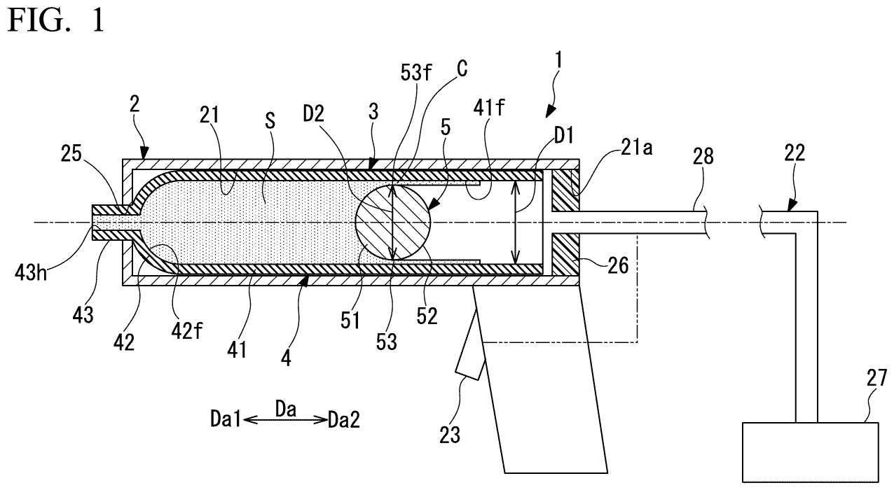

As shown in FIG. 1, a pneumatic dispenser 1 has a dispenser main body 2 and a cartridge 3 which is detachably loaded in the dispenser main body 2.

### (Constitution of Cartridge)

The cartridge 3 includes a cylinder 4 and a plunger 5.

The cylinder 4 integrally has a tubular portion 41 and an end wall portion 42.

The tubular portion 41 is formed to have a tubular shape extending in an axial direction Da.

In the present embodiment, the tubular portion 41 is formed to have a cylindrical shape having a constant inner diameter D1 in the axial direction Da.

The end wall portion 42 is formed in an end portion of the tubular portion 41 on a first side Da1 in the axial direction Da.

In the end wall portion 42, an inner surface 42f facing a second side Da2 in the axial direction Da is recessed in a hemispherical shape toward the first side Da1 in the axial direction Da.

In the end wall portion 42, a nozzle attachment portion 43 protruding to the first side Da1 in the axial direction Da is formed.

In the nozzle attachment portion 43, a discharge port 43h extending in the axial direction Da is formed.

The inside of the tubular portion 41 of the cylinder 4 and the outside of the cylinder 4 communicate with each other through the discharge port 43h.

In the nozzle attachment portion 43, a nozzle (not shown) having a suitable shape is constituted in a mountable manner.

For example, such a cartridge 3 is formed of a synthetic resin material such as polyethylene (PE) or POM.

A viscous material S can be accommodated inside the tubular portion 41 of such a cylinder 4.

For example, the viscous material S fills the inside of the tubular portion 41 through the discharge port 43h.

Examples of the viscous material S filling the cylinder 4 include a sealant material, an insulating material, and an adhesive.

The plunger 5 is provided in a manner of being able to move forward and backward in the axial direction Da inside the cylinder 4.

For example, the plunger 5 may be able to rotate when it moves forward and backward in the axial direction Da inside the cylinder 4.

The plunger 5 has a spherical shape.

For example, such a plunger 5 is formed of a synthetic resin material such as polyethylene (PE) or POM.

The plunger 5 may be hollow with a space formed therein. However, in the present embodiment, the plunger 5 is formed to be solid having no space therein.

An outer surface of the plunger 5 is formed to be a smooth curved surface with no irregularities.

The plunger 5 has a diameter expansion portion 51, a diameter reduction portion 52, and a largest diameter portion 53.

In the diameter expansion portion 51, the outer diameter gradually increases from the first side Da1 facing the discharge port 43h side in the axial direction Da toward the second side Da2 on a side opposite to the discharge port 43h side.

The diameter expansion portion 51 swells in a hemispherical shape toward the first side Da1 in the axial direction Da.

The diameter reduction portion 52 is formed on the second side Da2 in the axial direction Da with respect to the diameter expansion portion 51.

In the diameter reduction portion 52, the outer diameter gradually decreases from the first side Da1 in the axial direction Da toward the second side Da2.

The diameter reduction portion 52 swells in a hemispherical shape toward the second side Da2 in the axial direction Da.

The largest diameter portion 53 is formed between the diameter expansion portion 51 and the diameter reduction portion 52 in the axial direction Da.

The largest diameter portion 53 is a part in which the outer diameter in a direction intersecting the axial direction Da (radial direction) becomes the largest in the plunger 5.

The outer diameter of the plunger 5, that is, an outer diameter D2 of the largest diameter portion 53 is smaller than the inner diameter D1 of the tubular portion 41 of the cylinder 4.

The outer diameter D2 is set to be smaller than the inner diameter D1 by approximately 0.5 to 1.0 mm, for example.

Accordingly, a clearance C is formed in the radial direction intersecting the axial direction Da between an inner circumferential surface 41f of the tubular portion 41 of the cylinder 4 and an outer circumferential surface 53f of the largest diameter portion 53 of the plunger 5.

### (Constitution of Dispenser Main Body)

The dispenser main body 2 mainly includes a cartridge accommodation portion 21, an air pressure supply portion 22, and a trigger 23.

The cartridge accommodation portion 21 is constituted to be able to accommodate the cartridge 3.

The cartridge accommodation portion 21 is formed to have a cylindrical shape extending in the axial direction Da.

The cartridge accommodation portion 21 has an inner diameter slightly larger than the outer diameter of the cartridge 3.

On the first side Da1 of the cartridge accommodation portion 21 in the axial direction Da, a nozzle hole 25 is formed such that the outside of the dispenser main body 2 and the cartridge accommodation portion 21 communicate with each other.

The nozzle hole 25 is formed to have a diameter smaller than the inner diameter of the cartridge accommodation portion 21.

The nozzle attachment portion 43 is inserted through the nozzle hole 25.

The nozzle attachment portion 43 protrudes to the outside of the dispenser main body 2 through the nozzle hole 25.

The cartridge accommodation portion 21 has an opening portion 21a toward the second side Da2 in the axial direction Da.

The cartridge 3 is detachably loaded into the cartridge accommodation portion 21 through the opening portion 21a.

The opening portion 21a is closed by a detachable lid 26.

The air pressure supply portion 22 supplies air pressure to the inside of the cylinder 4 of the cartridge 3 which has been loaded in the cartridge accommodation portion 21.

The air pressure supply portion 22 includes a supply source 27 such as a compressor for supplying compressed air, and a supply piping 28 connected to the supply source 27.

For example, plant air may be used as the air pressure supply portion 22.

The supply piping 28 penetrates the lid 26 and is connected to the dispenser main body 2 such that air pressure is supplied to the second side Da2 in the axial direction Da with respect to the plunger 5 inside the cylinder 4.

The trigger 23 performs an opening/closing operation of a valve (not shown) provided in the supply piping 28.

The trigger 23 intermittently supplies air pressure through the supply piping 28 in response to an operation of a worker.

When the opening degree of the trigger 23 is adjusted in response to an operation of the worker, the supply amount of air pressure through the supply piping 28 is adjusted.

In such a pneumatic dispenser 1, the inside of the cylinder 4 of the cartridge 3 is filled with the viscous material S in advance on the first side Da1 in the axial direction Da with respect to the plunger 5.

The worker loads this cartridge 3 into the cartridge accommodation portion 21 of the dispenser main body 2.

As necessary, the worker attaches a nozzle (not shown), which is suitable for coating or filling a predetermined target area with the viscous material S, to the nozzle attachment portion 43.

The worker operates the trigger 23 in a state in which the nozzle (not shown) is brought close to or pressed against a target area. Then, compressed air supplied from the supply source 27 is fed into the cylinder 4 of the cartridge 3 through the supply piping 28, and due to the air pressure thereof, the plunger 5 is pushed to the first side Da1 in the axial direction Da inside the cylinder 4.

Accordingly, the viscous material S inside the cylinder 4 is pushed out through the discharge port 43h, and a predetermined target area is coated or filled therewith.

The clearance C is formed between the inner circumferential surface 41f of the cylinder 4 and the outer circumferential surface 53f of the largest diameter portion 53 of the plunger 5.

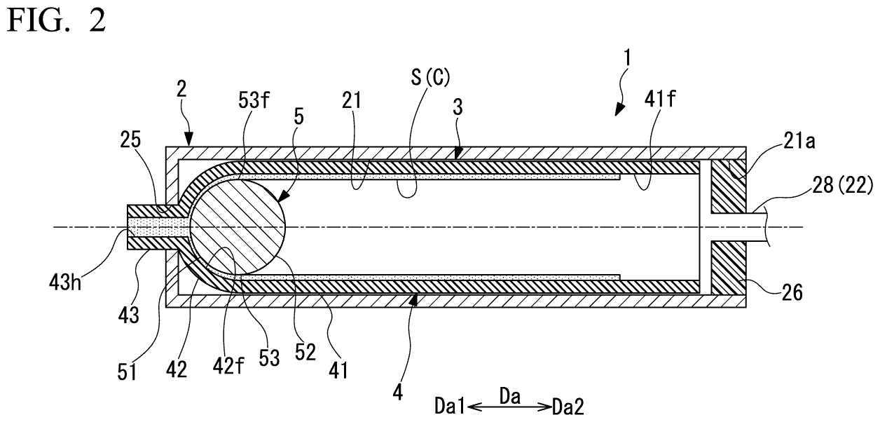

As shown in FIG. 2, if the plunger 5 moves to the first side Da1 in the axial direction Da inside the cylinder 4 due to an air pressure, the viscous material S remains in a part of the clearance C of the outer circumferential surface 53f on the outer circumferential side in a state of adhering to the inner circumferential surface 41f of the cylinder 4. In particular, the clearance C between the inner circumferential surface 41f of the cylinder 4 and the outer circumferential surface 53f of the largest diameter portion 53 of the plunger 5 is filled with the viscous material S.

The plunger 5 is held to be positioned in a central portion of the cylinder 4 due to the viscous material S on the outer circumferential side. Accordingly, the clearance C continues throughout the entire circumference in the circumferential direction around the axial direction Da.

### (Operational Effects)

In the present embodiment, in the cartridge 3, the plunger 5 has a spherical shape. Therefore, compared to when the plunger 5 has a tubular shape, concentration of stress received from the viscous material S entering between the cylinder 4 and the plunger 5 is unlikely to occur. As a result, occurrence of damage such as cracking in the plunger 5 is curbed so that durability of the cartridge 3 can be enhanced. In addition, when the plunger 5 is pushed by an air pressure and moves inside the cylinder 4, even if the plunger 5 rotates, interference between the plunger 5 and the cylinder 4 is curbed. Accordingly, hindrance to movement of the plunger 5 or occurrence of unnecessary stress acting on the plunger 5 or the cylinder 4 is curbed. Therefore, abrasion or damage to the plunger 5 or the cylinder 4 is curbed.

In addition, it is possible to constitute the pneumatic dispenser 1 having exceptional durability using the cartridge 3 in which concentration of stress is unlikely to occur in this manner.

In addition, the spherical plunger 5 has the diameter expansion portion 51, the diameter reduction portion 52, and the largest diameter portion 53 between the diameter expansion portion 51 and the diameter reduction portion 52. Accordingly, in the plunger 5, the outer circumferential surface 53f thereof comes close to the inner circumferential surface 41f of the cylinder 4 only in the vicinity of part of the largest diameter portion 53 in the axial direction Da. For this reason, for example, when air is mixed into the viscous material S, the air is likely to escape through the clearance C between the inner circumferential surface 41f of the cylinder 4 and the largest diameter portion 53 of the plunger 5. In addition, when the plunger 5 moves forward and backward in the axial direction Da inside the cylinder 4, the resistance received from the viscous material S which has adhered to the inner circumferential surface 41f of the cylinder 4 is small so that the plunger 5 is more likely to move forward and backward.

In addition, when the plunger 5 is pushed to the first side Da1 in the axial direction Da inside the cylinder 4, the gap between the hemispherical diameter expansion portion 51 of the plunger 5 and the hemispherical inner surface 42f becomes smaller by forming the inner surface 42f of the cylinder 4 into a hemispherical shape. In particular, a situation in which the viscous material S remains inside the cylinder 4 can be curbed, and the yield of the viscous material S is improved. In addition, stress concentration is unlikely to occur in an end portion of the cylinder 4 on the first side Da1 in the axial direction Da.

In addition, the clearance C which continues throughout the entire circumference in the circumferential direction is formed between the inner circumferential surface 41f of the cylinder 4 and the outer circumferential surface 53f of the plunger 5. Accordingly, the viscous material S inside the cylinder 4 enters the clearance C between the inner circumferential surface 41f of the cylinder 4 and the outer circumferential surface 53f of the plunger 5. Therefore, air is unlikely to enter from the second side Da2 to the first side Da1 in the axial direction Da with the plunger 5 therebetween.

In addition, since the plunger 5 is solid, stress concentration with respect to the plunger 5 is less likely to occur.

In addition, stress concentration with respect to the plunger 5 is less likely to occur by forming the outer surface of the plunger 5 smoothly with no irregularities. In addition, occurrence of abrasion or the like of the plunger 5 due to interference between the plunger 5 and the cylinder 4 is curbed.

In the foregoing embodiment, the plunger 5 has a spherical shape, but the embodiment is not limited thereto. For example, the plunger 5 may have a pseudo-spherical shape, an oval spherical shape, a polyhedral shape, or the like. In such cases, the plunger 5 may be hollow or may be solid. In addition, for example, when the plunger 5 is formed to have a polyhedral shape, the cylinder 4 may be constituted to have a polygonal shape corresponding to the polyhedral shape plunger 5.

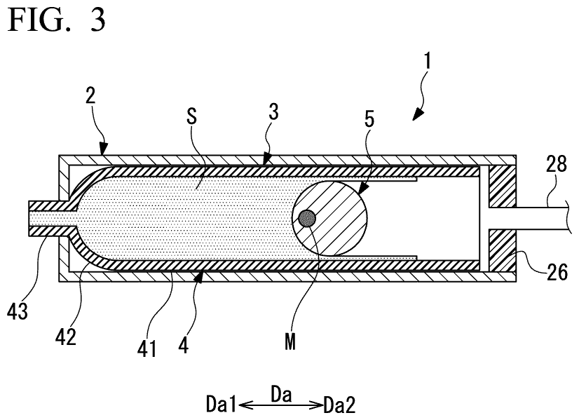

In the foregoing embodiment, the centroid position of the plunger 5 may be made eccentric. To this end, for example, as shown in FIG. 3, inside the plunger 5, a metal mass body M, of which the specific gravity is greater than that of the material forming the plunger 5, may be buried at a position eccentric from the center of the plunger 5. In this manner, for example, it is expected to achieve an operational effect such as enhancement of stability in operation of forward/backward movement of the plunger 5 inside the cylinder 4 by causing the centroid of the plunger 5 to be eccentric to the first side Da1 in the axial direction Da inside the cylinder 4.

Hereinabove, several embodiments of the present disclosure have been described, but these embodiments are presented as examples and are not intended to limit the scope of the disclosure. These embodiments can be performed in various other forms, and various omissions, replacements, and changes can be performed within a range not departing from the gist of the disclosure. It is assumed that these embodiments and modification thereof are included in the claims and the scope equivalent thereto as well as in the scope and the gist of the disclosure.

### APPENDIX

The cartridge 3 and the pneumatic dispenser 1 according to the embodiment are ascertained as follows, for example.

(1) A cartridge 3 according to a first aspect capable of being loaded in a pneumatic dispenser 1. The cartridge 3 includes a cylinder 4 including a tubular portion 41 capable of accommodating a viscous material S therein and a discharge port 43h for discharging the viscous material S inside the tubular portion 41, the tubular portion 41 having a tubular shape extending in an axial direction Da, and a plunger 5 that is provided in a manner of being able to move forward and backward in the axial direction Da inside the cylinder 4 and has any one of a spherical shape, a pseudo-spherical shape, an oval spherical shape, and a polyhedral shape.

In this cartridge 3, the plunger 5 has any one of a spherical shape, a pseudo-spherical shape, an oval spherical shape, and a polyhedral shape. Therefore, compared to when the plunger 5 has a tubular shape, concentration of stress received from the viscous material S entering between the cylinder 4 and the plunger 5 is unlikely to occur.

(2) The cartridge 3 according to a second aspect is the cartridge 3 according to (1), in which the plunger 5 has a diameter expansion portion 51 of which an outer diameter gradually increases from a first side Da1 facing a side of the discharge port 43h toward a second side Da2 on a side opposite to the side of the discharge port 43h in the axial direction Da, a diameter reduction portion 52 which is formed on the second side Da2 in the axial direction Da with respect to the diameter expansion portion 51 and of which an outer diameter gradually decreases from the first side Da1 toward the second side Da2 in the axial direction Da, and a largest diameter portion 53 which is formed between the diameter expansion portion 51 and the diameter reduction portion 52 and has the largest outer diameter.

Accordingly, the plunger 5 having any one of a spherical shape, a pseudo-spherical shape, an oval spherical shape, and a polyhedral shape has the diameter expansion portion 51, the diameter reduction portion 52, and the largest diameter portion 53 between the diameter expansion portion 51 and the diameter reduction portion 52.

Accordingly, the plunger 5 no longer has a tubular shape. In the plunger 5, an outer circumferential surface 53f thereof comes close to an inner circumferential surface 41f of the cylinder 4 only in the vicinity of a part of the largest diameter portion 53. For this reason, for example, when air is mixed into the viscous material S, the air is likely to escape through a clearance C between the inner circumferential surface 41f of the cylinder 4 and the largest diameter portion 53 of the plunger 5. In addition, when the plunger 5 moves forward and backward in the axial direction Da inside the cylinder 4, the resistance received from the viscous material S which has adhered to the inner circumferential surface 41f of the cylinder 4 is small so that the plunger 5 is more likely to move forward and backward.

(3) The cartridge 3 according to a third aspect is the cartridge 3 according to (1) or (2), in which an inner surface 42f of the cylinder 4 on the first side Da1 in the axial direction Da is formed to have a hemispherical shape.

Accordingly, when the plunger 5 is pushed to the first side Da1 in the axial direction Da inside the cylinder 4, a gap between the plunger 5 and the hemispherical inner surface 42f becomes smaller by forming the inner surface 42f of the cylinder 4 on the first side Da1 in the axial direction Da into a hemispherical shape. Accordingly, a situation in which the viscous material S remains inside the cylinder 4 can be curbed, and the yield of the viscous material S is improved. In addition, stress concentration is unlikely to occur in an end portion of the cylinder 4 on the first side Da1 in the axial direction Da.

(4) The cartridge 3 according to a fourth aspect is the cartridge 3 according to any one of (1) to (3), in which a clearance C which continues throughout an entire circumference in a circumferential direction centered in the axial direction Da is formed between an inner circumferential surface 41f of the cylinder 4 and an outer circumferential surface 53f of the plunger 5.

Accordingly, the viscous material S inside the cylinder 4 enters the clearance C between the inner circumferential surface 41f of the cylinder 4 and the outer circumferential surface 53f of the plunger 5. Accordingly, the ability to seal between the inner circumferential surface 41f of the cylinder 4 and the outer circumferential surface 53f of the plunger 5 is enhanced. Therefore, air is unlikely to enter from the second side Da2 to the first side Da1 in the axial direction Da with the plunger 5 therebetween.

(5) The cartridge 3 according to a fifth aspect is the cartridge 3 according to any one of (1) to (4), in which the plunger 5 is solid.

Accordingly, since the plunger 5 is solid, stress concentration with respect to the plunger 5 is less likely to occur.

(6) The cartridge 3 according to a sixth aspect is the cartridge 3 according to any one of (1) to (5), in which an outer surface of the plunger 5 is formed smoothly.

Accordingly, stress concentration with respect to the plunger 5 is less likely to occur by forming the outer surface of the plunger 5 smoothly with no irregularities.

(7) The cartridge 3 according to a seventh aspect is the cartridge 3 according to any one of (1) to (6), in which a centroid position of the plunger 5 is eccentric.

Accordingly, the stability in operation of forward/backward movement of the plunger 5 inside the cylinder 4 can be enhanced.

(8) A pneumatic dispenser 1 according to an eighth aspect includes the cartridge 3 according to any one of (1) to (7), a cartridge accommodation portion 21 that is capable of accommodating the cartridge 3, and air pressure supply portion 22 that supplies an air pressure to the cartridge 3 accommodated in the cartridge accommodation portion 21 and pushes the plunger 5 in the axial direction Da inside the cylinder 4.

Accordingly, it is possible to constitute the pneumatic dispenser 1 using the cartridge 3 in which concentration of stress received from the viscous material S entering between the cylinder 4 and the plunger 5 is unlikely to occur.

### INDUSTRIAL APPLICABILITY

According to a cartridge and a pneumatic dispenser of the present disclosure, stress is unlikely to be concentrated with respect to a plunger.

### REFERENCE SIGNS LIST

1 Pneumatic dispenser
2 Dispenser main body
3 Cartridge
4 Cylinder
5 Plunger
21 Cartridge accommodation portion
21a Opening portion
22 Air pressure supply portion
23 Trigger
25 Nozzle hole
26 Lid
27 Supply source
28 Supply piping
41 Tubular portion
41f Inner circumferential surface
42 End wall portion
42f Inner surface
43 Nozzle attachment portion
43h Discharge port
51 Diameter expansion portion
52 Diameter reduction portion
53 Largest diameter portion
53f Outer circumferential surface
C Clearance
D1 Inner diameter
D2 Outer diameter
Da Axial direction
Da1 First side
Da2 Second side
M Mass body
S Viscous material

1. A cartridge for a pneumatic dispenser, the cartridge comprising:
a cylinder including a tubular portion configured to accommodate a viscous material inside the tubular portion and a discharge configured to discharge the viscous material inside the tubular portion, the tubular portion having a tubular shape extending in an axial direction; and
a plunger configured to move forward and backward in the axial direction inside the cylinder and has any one of a spherical shape, a pseudo-spherical shape, an oval spherical shape, and a polyhedral shape.

2. The cartridge according to claim 1,
wherein the plunger has
a diameter expansion portion of which an outer diameter gradually increases from a first side facing a side of the discharge port toward a second side on a side opposite to the side of the discharge port in the axial direction,
a diameter reduction portion which is formed on the second side in the axial direction with respect to the diameter expansion portion and of which an outer diameter gradually decreases from the first side toward the second side in the axial direction, and
a largest diameter portion between the diameter expansion portion and the diameter reduction portion, the largest diameter portion having a largest outer diameter in the plunger.

3. The cartridge according to claim 1,
wherein an inner surface of the cylinder on the first side in the axial direction has a hemispherical shape.

4. The cartridge according to claim 1,
wherein the cartridge has a clearance between an inner circumferential surface of the cylinder and an outer circumferential surface of the plunger, the clearance continuing throughout an entire circumference in a circumferential direction centered in the axial direction.

5. The cartridge according to claim 1,
wherein the plunger is solid.

6. The cartridge according to claim 1,
wherein an outer circumferential surface of the plunger is smooth.

7. The cartridge according to claim 1,
wherein a centroid position of the plunger is eccentric.

8. A pneumatic dispenser comprising:
the cartridge according to claim 1;
a cartridge accommodation portion configured to accommodate the cartridge; and
an air pressure supply portion configured to supply air pressure to the cartridge accommodated in the cartridge accommodation portion and push the plunger in the axial direction inside the cylinder.
